(19) United States
(12) Patent Application Publication
(10) Pub. No.: US 2010/0257773 A1
(43) Pub. Date: Oct. 14, 2010

(54) Mousetrap

(76) Inventor: Jim O'Dell, Richmond, MO (US)

Correspondence Address: LATHROP & GAGE LLP, 2345 GRAND Boulevard, SUITE 2400, KANSAS CITY, MO, 64108, US

(21) Appl. No.: 12/475,187

(22) Filed: May 29, 2009

Related U.S. Application Data
(60) Provisional application No. 61/168,864, filed on Apr. 13, 2009.

(51) Int. Cl. A01M 23/24

(52) U.S. Cl. 43/88; 43/81; 43/90

(57) ABSTRACT

An improved mousetrap has an upper jaw pivotally mounted with a lower jaw, and a bait platform mounted between the upper and lower jaws, The bait platform acts as a trigger to initiate jaw closure when depressed. A circumferential spring for closing the jaws around the bait platform encircles the jaws and is retained in a retaining groove of the lower jaw. The upper jaw has a rear, lower corner for retaining the spring when the jaws are open; and a rear, upper corner for retaining the spring when the jaws are closed. Contractile force of the spring pulls the spring from the lower corner toward the upper corner, to complete jaw closure.

### RELATED APPLICATIONS

This application claims benefit and priority to Provisional U.S. Patent Application Ser. No. 61/168,864, filed Apr. 13, 2009, the disclosure of which is incorporated herein by reference.

### BACKGROUND

People wishing to eliminate mice and other rodents from a building or area often use a mousetrap to trap and kill the animals. Some mousetraps have a metal bail pivoted to the middle of a base with a torsion spring. To set the trap, the user rotates the free end of the bail toward one end of the base, engaging the free end with a catch, against the force of the spring.

U.S. Pat. No. 4,991,340 to Schildt, incorporated herein by reference, discloses a mousetrap wherein two jaws are pivoted together and encircled by a single continuous garter-like spring, which is positioned at or slightly behind the pivot axis. Thus, the spring does not exert any closing force upon the jaws when the jaws are in the open position; rather, the spring aids in holding the jaws open. A teeter-totter trigger with a bait platform connects with the upper jaw. When a mouse exerts downward pressure on the bait platform, i.e., in attempting to remove the bait, the upper jaw is rotated slightly forward. The continuous spring then slides upward/forward along the upper jaw, causing the upper jaw to snap shut against the lower jaw.

U.S. Pat. No. 6,415,544 to Leyerle, incorporated herein by reference, discloses a rodent trap with entrapping teeth. When the trap is sprung, the teeth interdigitate and close together to catch rodents therebetween.

### SUMMARY OF THE INVENTION

In embodiments, an improved mousetrap includes an upper jaw pivotally mounted relative to a lower jaw. A bait platform mounted between the upper and lower jaws acts as a trigger to initiate jaw closure when depressed. A circumferential spring for closing the jaws around the bait platform encircles the jaws and is retained in a retaining groove of the lower jaw. The upper jaw has a rear, lower corner for retaining the spring when the jaws are open, and a rear, upper corner for retaining the spring when the jaws are closed. Contractile force of the spring pulls the spring from the lower corner toward the upper corner, to complete jaw closure.

In one embodiment, in a mousetrap having pivotal upper and lower jaws joined with a continuous garter spring, an improvement includes a bait receiving location, e.g., a cup in some embodiments, mounted on a bait platform, proximate a pivot point of the jaws; and a cutout in a rear portion of the upper jaw, for accessing the bait cup when the jaws are closed. A pair of vertical sidewalls prevent access to the bait cup from the sides of the trap.

In one embodiment, an improved mousetrap includes a base, a lower jaw mounted with the base and an upper jaw pivotally mounted with the lower jaw. A bait platform mounts between the upper and lower jaws, acting as a trigger to initiate jaw closure when depressed. A pair of sidewalls extend vertically from the base and outside of the upper and lower jaws, to prevent access to the bait platform from the sides of the mousetrap. A circumferential spring for closing the jaws around the bait platform encircles the jaws and is retained in a retaining groove of the base. The upper jaw includes a rear, lower corner for retaining the spring when the jaws are open, and a rear, upper corner for retaining the spring when the jaws are closed. Contractile force of the spring pulls the spring toward the upper corner, to complete jaw closure.

### BRIEF DESCRIPTION OF THE DRAWINGS

FIG. 1 is a front perspective view of an improved mousetrap in an open, set position, according to an embodiment.

FIG. 2 is a front perspective view of the mousetrap of FIG. 1, in a closed, sprung position.

FIG. 3 is an exploded view of the mousetrap if FIGS. 1 and 2.

FIG. 4 is a rear perspective view of the closed, sprung mousetrap shown in FIG. 2.

FIG. 5a is a cross-sectional side view through the closed, sprung mousetrap of FIGS. 2 and 4.

FIG. 5b is a cross-sectional side view through the open, set mousetrap of FIG. 1.

### DETAILED DESCRIPTION

For ease of discussion, the trap detailed herein is referred to as a mousetrap. However, it will be appreciated that the disclosed trap may be used to capture and/or kill any rodent or small animal. Thus, the use of the term “mousetrap” in these descriptive materials should not be construed as an indication of limited utility or in any other way restrictive in terms of scope.

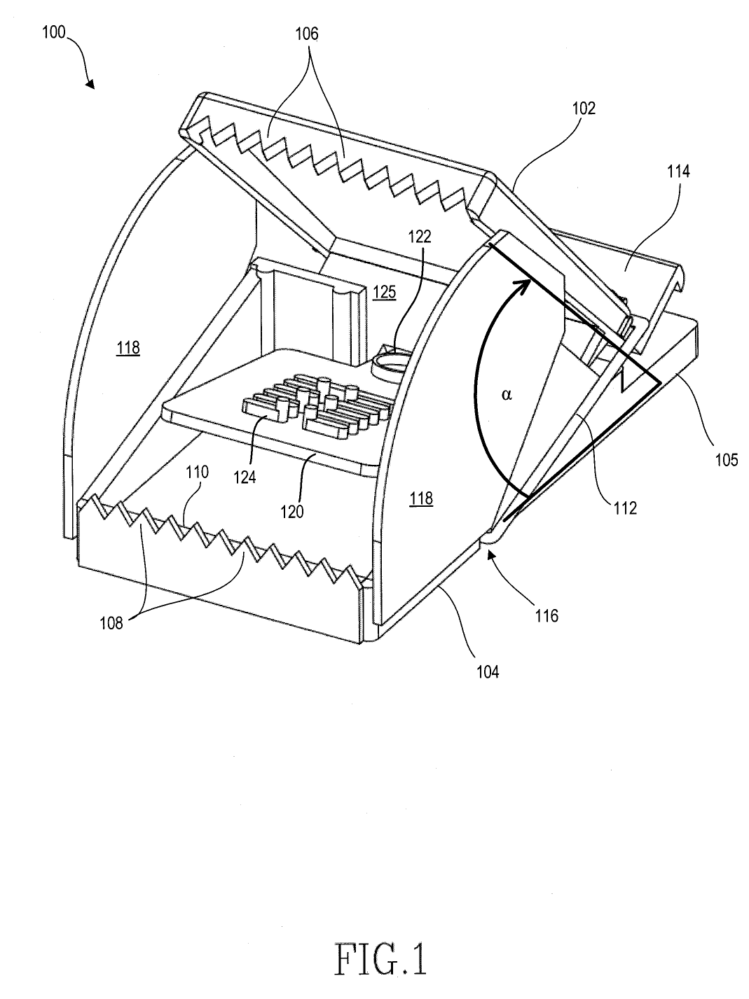

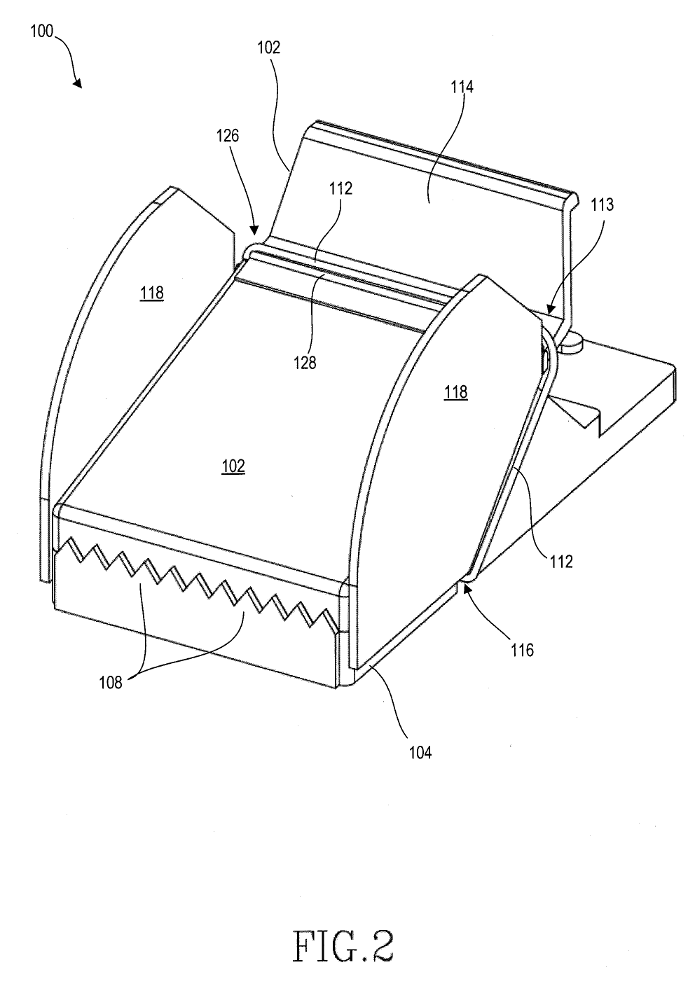

FIGS. 1 and 2 show a mousetrap 100 in open (set) and closed (sprung) positions, respectively. For purposes of the following description, FIGS. 1 and 2 are best viewed together.

FIG. 1 shows mousetrap 100 in open, set position. Mousetrap 100 includes an upper jaw 102 and a lower jaw 104 configured with a base 105. Lower jaw 104 may be formed with base 105, or lower jaw 104 may be separately formed and mounted with base 105.

Upper teeth 106 extend downward from upper jaw 102, and lower teeth 108 extend upward from lower jaw 104. As shown in FIG. 1, lower teeth 108 are backed by a rail 110. A continuous, encircling band or spring 112 holds upper and lower jaws 102, 104 together. Spring 112 may be a garter-like metal spring, an elastic band, a rubber band or a band or spring of another strong, stretchable material having contractile properties. When trap 100 is set, spring 112 is stretched to rest in a lower corner 113 formed by an upwardly extending tail portion 114 of upper jaw 102 (see FIG. 2). A retaining groove 116 holds spring 112 in place underneath and along base 105/lower jaw 104.

A pair of substantially vertical sidewalls 118 mount with lower jaw 104/base 105 and extend upwards to approximately the height of upper jaw 102, when trap 100 is open. As shown, sidewalls 118 are formed with arcs imitative of the path of upper jaw 106 as trap 100 closes. Sidewalls 118 are also shown tapering downwards from front to back of trap 100. However, sidewalls 118 may take alternate shapes and sizes.

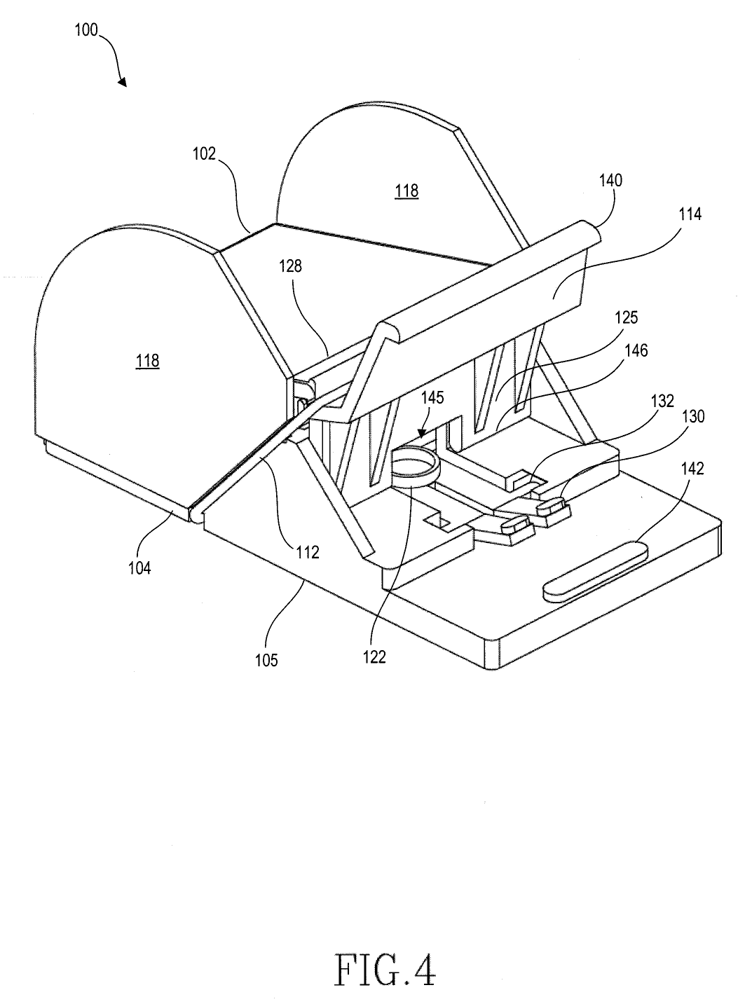

A bait platform 120 mounts with trap 100 such that the platform and a bait cup 122 are exposed when trap 100 is open. A textured portion of bait platform, such as ridges 124, provide traction for a mouse or other rodent attempting to climb atop bait platform 120 to reach bait in bait cup 122. A foot portion 125 of upper jaw 102 joins with or pivots with bait platform 120. See description of FIG. 4, below. When a mouse exerts downward pressure on bait platform 120, platform 120 “teeter-totters” under the mouse's weight, triggering trap 100 and closing upper jaw 102 slightly. The slight closure of upper jaw 102 reduces an angle α between upper jaw 102 and base 105/lower jaw 104. Upon reduction of angle α, compressive force of spring 112 snaps upper and lower jaws 102, 104 shut. For example, spring 112 contracts, sliding from lower corner 113 to an upper corner 126 formed by upper jaw 102 and a retainer 128, closing jaws 102, 104. See also FIG. 4. Upper teeth 106 shut against rail 110, which is for example lower in height than lower teeth 106. Lower teeth 108 extend farther forward than lower teeth 106, such that trap 100 closes with an underbite. Jaws 102, 104 thereby close further than jaws with interdigitating teeth (i.e., the interdigitating teeth described in U.S. Pat. No. 6,145,544, cited above), enabling the jaws to collapse further and create an offset bite at the interface of the vertically overlapping teeth 106 and 108, rather than the end-to-end bite of conventional teeth sets which are coplanar and mesh. Once trap 100 has collapsed on the rodent, the underbite relationship between teeth 106 and 108 also forms an additional obstacle to a rodent attempting to back out or pull a limb out of trap 100. When trap 100 is closed, lower teeth 108 form a “fence” or barrier to escape. Rather than pulling/moving straight back to escape a conventional trap, the rodent must pull/move back and up, over the barrier in order to overcome retention.

Mousetrap 100 may thereby decrease rates of rodent escape. In one embodiment, the underbite of trap 100 (e.g., the spacing between upper and lower jaws 102, 104 when trap 100 is closed) is about ⅛″. Lower teeth 108 may be formed with lower jaw 104, or lower teeth 108 may be fastened to lower jaw 104 with adhesive, screws, snaps or other fasteners.

Sidewalls 118 block rodents from accessing bait via the sides of trap 100, and may thus decrease incidences of stolen bait while increasing catch and kill ratios. Because rodents cannot access bait from the sides of trap 100, but must enter the trap, maiming and escape are less likely, and kills more likely, than with conventional traps such as those described in U.S. Pat. Nos. 4,991,340 and 6,415,544 (briefly outlined above).

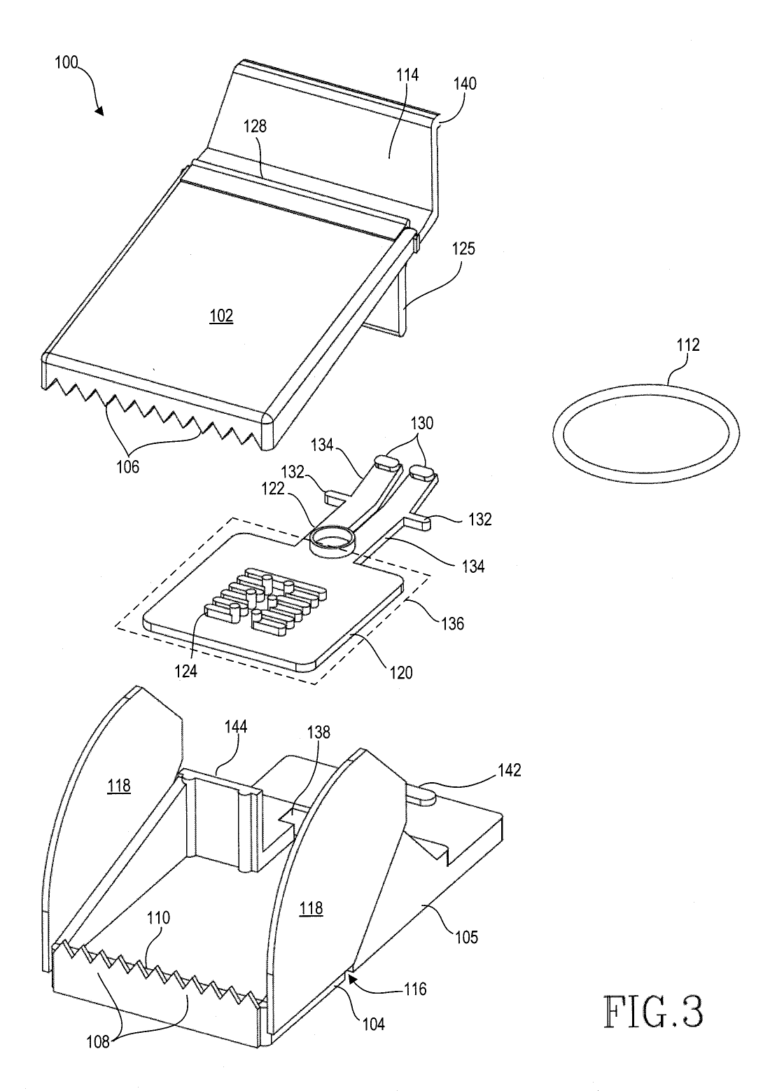

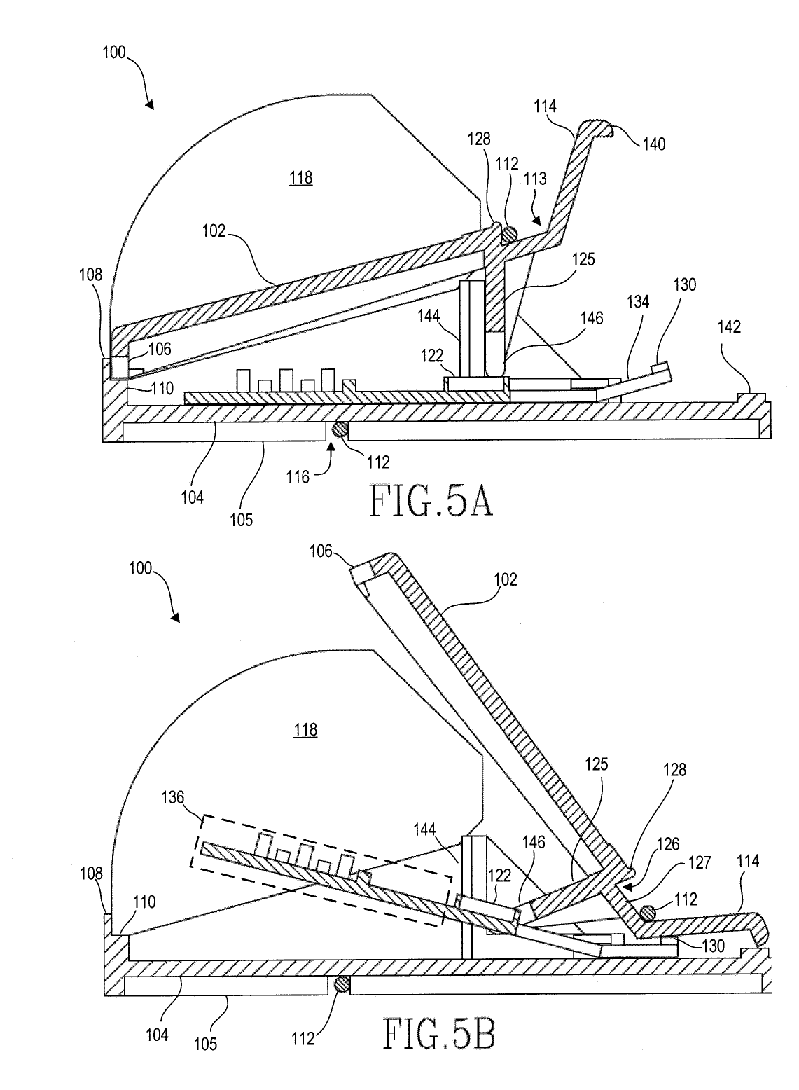

FIG. 3 is an exploded view of trap 100, showing additional detail of bait platform 120 and lower jaw 104/base 105. Bait platform 120 is shown with two rear and two side tabs 130, 132 extending from a pair of platform arms 134. Arms 134 bend proximate wings 132 and angle upwards towards tabs 130. When trap 100 is opened, i.e., by pressing downward on tail portion 114, an inner surface of tail 114 contacts rear tabs 130, pressing arms 134 down and elevating a trigger portion 136 (indicated in dashed outline) of platform 120. See FIG. 5b. When arms 134 are pressed down, platform 120 for example rocks or pivots on side tabs 132, within channels 138 in lower jaw 104. When trap 100 is open, a downwardly-extending tip 140 of tail portion 114 rests upon a stopper 142 configured with lower jaw 104/base 105. It will be appreciated that the bend in platform arms 134 may be varied (e.g., the angle increased or decreased) or the height of stopper 142 be increased or decreased to alter trigger sensitivity as desired.

Lower jaw 104/base 105 includes a pair of intermediate vertical walls 144. When trap 100 is closed, as shown in FIG. 4, foot portion 125 of upper jaw 102 rests behind and substantially parallel to walls 144. Jaws 102, 104 are closed together, and bait cup 122 is exposed for emptying/reloading. A user may safely remove and/or reload bait in bait cup 122 without having to reach into the mouth of an armed trap. As shown in FIG. 4, foot portion 125 may include a cutout 145 to facilitate access to bait cup 122. Bait cup 122 may be about ⅛″ to 3/16″ or taller in height, to prevent overflow of bait into the back of trap 100 when trap 100 is open and bait platform 120 tilts rearward. The height of cutout 145 may vary according to the height of bait cup 122, for example to facilitate placement of bait in bait cup 122.

When trap 100 is set, foot portion 125 of upper jaw 102 pivots against walls 114, along a base 146. See also FIG. 5b. Spring 112 slides from corner 126 to rest in corner 113, securing jaws 102, 104 in open position with tip 140 of upper jaw 102 resting against stopper 142.

FIGS. 5a and 5b are cross-sectional side views of mousetrap 100 in closed and open positions, respectively. According to one embodiment, FIGS. 5a and 5b show lower jaw 104 mounted with base 105. Base 105 includes retaining groove 116, and jaw 104 includes stopper 142. For clarity of illustration, not all components of trap 100 are shown in each figure. Thus, FIGS. 5a and 5b are best viewed together with the following description.

When closed, as in FIG. 5a, upper teeth 106 contact rail 110 of lower jaw 104. Lower teeth 108 overlap upper teeth 106 in an overbite, posing an additional barrier to escape from trap 100. Bait platform 120 is substantially flush with the inner, bottom aspect of lower jaw 104, except where platform arms 134 angle upward from lower jaw 104 at the bend proximate tabs 132 (see FIG. 3 and the description thereof). Platform arms 134 are exposed at the open, back end of trap 100. Bait cup 122 is accessible via cutout 145 (see FIG. 4). Spring 112 spans trap 100 laterally. Whether open or shut, spring 112 is located in a first position resting in retaining groove 116 of lower jaw 114. When the trap is in closed position, the opposite portion of spring 112 is located in an upper corner 126 of upper jaw 102. Contractile force of spring 112 maintains trap 100 in the closed position.

Advantageously, a user may remove a trapped rodent from trap 100 without touching the rodent. To do this, the user pinches tail portion 114 to lower jaw 104/base 105, opening jaws 102, 104. The trapped rodent may then be disposed of, e.g., by opening the trap over a garbage can.

Likewise, trap 100 may be reloaded with bait without having to reach between jaws 102, 104. As shown in FIG. 5a, bait cup 122 is accessible from the rear of trap 100, via cutout 145. Trap 100 may thus be safely baited without the risk to a user's fingers that is posed when a user must reach into a conventional trap (e.g., those described in U.S. Pat. Nos. 4,991,340 and 6,415,544) to bait it.

Once baited, trap 100 may be set by pressing tail portion 114 to lower jaw 104/base 105. Base 146 of foot portion 125 pivots against walls 114 to open upper jaw 102. Now that upper jaw 102 has been rocked backward, the slope of surface 127, and the influence of gravity together cause spring 112 to slide into a second position nested in lower corner 113. Contractile force of spring 112 keeps spring 112 proximate lower corner 113, maintaining trap 100 in open, set position since the spring 112 is now over center of the axis of rotation for the upper jaw 102. Tail portion 114 presses tabs 130 down such that arms 134 are substantially flush with lower jaw 104/base 105, from tabs 130 to tabs 132. From tabs 132 forward (e.g., from tabs 132 to the distal end of trigger portion 136), bait platform 120 extends upward between open jaws 102, 104. Sidewalls 118 (only one shown in FIGS. 5a and 5b) prevent access to bait cup 122 from the sides of the trap. Contrary to conventional traps, mousetrap 100 prevents mice from sneaking bait from the sides of the trap. Sidewalls 118 force mice in search of base into trap 100 and over trigger portion 136, increasing catch rates and simultaneously decreasing maimings that may occur when a rodent triggers a trap by reaching for bait via a side.

Upper jaw 104 (e.g., tail portion 114 and foot portion 125) closes with lower jaw 104/base 105 to likewise block access to bait cup 122 from the rear of trap 100. Thus, access to the bait is completely precluded from the back and sides, and a rodent must access bait cup 122 from between jaws 102, 104, for example by climbing upon trigger portion 136 of bait platform 120, and thereby triggering trap 100. Bait cup 122 is positioned sufficiently far back on bait platform 120 so that rodents cannot reach bait without stepping onto trigger portion 136. For example, as shown in FIG. 4, bait cup 122 is positioned partially within cutout 145.

In the above-described Figures, sidewalls 118 are shown extending upwards from lower jaw 104/base 105. However, it will be appreciated that trap 100 may alternatively include a fixed or removable canopy for covering at least a portion of trap 100. The canopy may include downwardly extending sidewalls, to replace or augment sidewalls 118.

It will be understood that certain changes may be made in the above systems and methods without departing from the scope hereof; thus, it is intended that all matter contained in the above description or shown in the accompanying drawings be interpreted as illustrative and not in a limiting sense. It is also to be understood that the following claims are to cover generic and specific features described herein, and all statements of the scope of the invention which, as a matter of language, might be said to fall there between.

What is claimed is:

1. An improved mousetrap, comprising:
an upper jaw pivotally mounted with a lower jaw;
a platform mounted between the upper and lower jaws, the platform acting as a trigger to initiate jaw closure when depressed;
a bait-receiving location, said bait-receiving location being located one of on or above said platform;
a circumferential spring for closing the jaws around the platform, the spring encircling the jaws and being retained in a retaining groove of the lower jaw;
the upper jaw comprising a rear, lower corner for retaining the spring when the jaws are open, and a rear, upper corner for retaining the spring when the jaws are closed;
wherein contractile force of the spring pulls the spring from the lower corner toward the upper corner, to complete jaw closure; and
said mousetrap precludes access to said bait location from rearward and lateral positions.

2. The mousetrap of claim 1, wherein the jaws close with an underbite.

3. The mousetrap of claim 1; the upper and lower jaws comprising teeth; the lower jaw further comprising a rail backing the lower teeth;
wherein the upper teeth close against the rail and the lower teeth form a barrier in front of the closed upper teeth.

4. The mousetrap of claim 1, the platform comprising a bait cup mounted proximate a pivot point of the upper and lower jaws; the bait cup loadable from the rear of the mousetrap, when the trap is closed, and
wherein the bait cup is inaccessible from the rear of the trap when the trap is open.

5. The mousetrap of claim 1, further comprising a pair of sidewalls extending upwards from the sides of the lower jaw; the sidewalls blocking access to the platform from the sides of the mousetrap.

6. The mousetrap of claim 5, wherein the sidewalls are perpendicular to the lower jaw.

7. The mousetrap of claim 1, further comprising a canopy for covering the jaws.

8. The mousetrap of claim 7, further comprising substantially vertical sidewalls extending downwards from the canopy, for blocking access to the platform from sides of the mousetrap.

9. In a mousetrap having pivotal upper and lower jaws joined with a continuous garter spring, the improvement comprising:
a bait cup mounted on a bait platform, proximate a pivot point of the jaws;
a cutout in a rear portion of the upper jaw, for accessing the bait cup when the jaws are closed; and
pair of vertical sidewalls for preventing access to the bait cup from the sides of the trap.

10. The mousetrap of claim 9, the upper and lower jaws comprising teeth.

11. The mousetrap of claim 10, wherein the lower teeth close in front of the upper teeth, in an underbite.

12. The mousetrap of claim 11, the lower jaw comprising a rail backing the lower teeth, the rail contacting the upper teeth when the jaws close.

13. The mousetrap of claim 9, further comprising a lower jaw extension mounted with the front of the lower jaw; the lower jaw extension forming a barrier in front of the upper and lower jaws, when the jaws are closed.

14. The mousetrap of claim 9, the sidewalls extending upwards from the lower jaw.

15. The mousetrap of claim 9, the sidewalls extending upwards from a base mounted with the lower jaw.

16. The mousetrap of claim 9, the sidewalls extending downwards from a canopy covering the mousetrap.

17. An improved mousetrap, comprising:
a base;
a lower jaw mounted with the base;
an upper jaw pivotally mounted with the lower jaw;
a bait platform mounted between the upper and lower jaws, the bait platform acting as a trigger to initiate jaw closure when depressed;
a pair of sidewalls extending vertically from the base and outside of the upper and lower jaws, to prevent access to the bait platform from the sides of the mousetrap;
a circumferential spring for closing the jaws around the bait platform, the spring encircling the jaws and being retained in a retaining groove of the base;
the upper jaw comprising a rear, lower corner for retaining the spring when the jaws are open, and a rear, upper corner for retaining the spring when the jaws are closed;
wherein contractile force of the spring pulls the spring toward the upper corner, to complete jaw closure.

18. The mousetrap of claim 17, a pivot point of the upper and lower jaws located proximate the rear of the mousetrap; the bait platform comprising a bait cup mounted proximate the pivot point; the upper jaw comprising a downwardly extending foot portion; the foot portion blocking access to the inside of the trap from the rear of the trap.

19. The mousetrap of claim 18, the foot portion comprising a cutout for facilitating access to the bait cup from the rear of the trap, when the trap is closed.

20. An animal trap, comprising:
a first jaw pivotally mounted to a base member, said base member defining an opposing second jaw;
a triggering mechanism located between said jaws;
a bait-receiving location existing either on or above said triggering mechanism;
a biasing member for compelling said first and second jaws into a closed position upon activation of said triggering mechanism;
said trap being enclosed against access to said bait location from rearward and lateral positions.

21. The trap of claim 20 wherein said trap is enclosed against access to said bait location laterally by opposing side walls.

22. An animal trap, comprising:
a first jaw pivotally mounted to a base member, a portion of said base member defining a second jaw opposing said first jaw, said first jaw being biased away from said second jaw when said trap is in an open mode, said first jaw being biased towards said second jaw when said trap is in a closed mode;
a triggering mechanism which when operated causes said trap to go from said open mode into said closed mode when an animal enters between said first and second jaws; and
a designated bait-receiving area; said bait-receiving area being located to be accessible for loading when said trap is in said closed mode, and accessible to an animal through said first and second jaws when said trap is in said open mode.

23. An animal trap, comprising:
an upper jaw pivotally mounted to a base member, a portion of said base member defining a second jaw opposing said first jaw, said first jaw being biased away from said second jaw when said trap is in an open mode, said first jaw being biased towards said second jaw when said trap is in a closed mode;
a triggering mechanism which when operated causes said trap to go from said open mode into said closed mode when an animal enters between said first and second jaws; and
at least one downwardly-depending catch member located at a forward position of said first jaw;
at least one upwardly-extending catch member at a forward position of said second jaw; and
said at least one downwardly-depending catch member being vertically offset relative to said upwardly-extending catch member when said trap is in said closed mode.

24. The trap of claim 23 wherein said at least one downwardly-depending catch member is a first row of teeth and said at least one upwardly-extending catch member is a second opposing row of teeth wherein upon activation of said triggering mechanism, said first and second rows collapse against each other.
